(19) United States
(12) Patent Application Publication
(10) Pub. No.: US 2001/0031187 A1
(43) Pub. Date: Oct. 18, 2001

(54) Pull with pivoting tie-down hoop

(76) Inventors: Thomas D. Goham, West Chester, PA (US); Eric Hollerbach, Grosse Pointe Park, MI (US)

Correspondence Address: H. Steve Ngo, Paul and Paul, 2900 Two Thousand Market Street, Philadelphia, PA, 19103, US

(21) Appl. No.: 09/733,298

(22) Filed: Dec. 8, 2000

Related U.S. Application Data
(60) Provisional application No. 60/170,288, filed on Dec. 10, 1999.

(51) Int. Cl. B60P 7/08

(52) U.S. Cl. 410/106

(57) ABSTRACT

A pull has a concealable hoop that pivots into a housing when not in use to enhance the appearance of a vehicle storage area. The pull pivots 360° during use, thereby permitting the hoop to be aligned with the force applied by a cord secured to the hoop.

### BACKGROUND OF THE INVENTION

1. Field of the Invention

The invention is a pull having a concealable hoop that pivots 360° during use.

2. Description of the Related Art

Various pulls have been proposed by other inventors. An example of a current pull is illustrated in Southco, Inc. Catalog No. 48 NA, p. L-6, 1998. This pull includes a hoop that pivots into a housing for concealment when not in use. However, it lacks the ability of rotate to align itself with the force applied when a cord is secured to it.

The above-referenced publication is not seen to describe the present invention as claimed.

### SUMMARY OF THE INVENTION

The invention is a pull having a concealable hoop that pivots 360° during use. The pull includes a hoop pivotally secured to a plate, which is in turn pivotally secured within a housing.

The housing includes a pair of sides, a pair of ends, a bottom, an interior defined therewithin, a top flange, and a pair of hollow bosses within the top flange for receiving mounting screws. The plate is pivotally secured near the top of the housing, preferably with a pin. The plate includes an elongated base and a central hollow stem. The stem is preferably angled with respect to the base, so that when the stem is vertical the base is angled from the horizontal. The hoop includes a flat base and a curved gripping portion. The hoop is secured to the plate by a stud passing through the hoop's base and plate's hollow stem. The bolt may be secured within the stem by the pin passing through a hole within the bolt.

In use, the pull will be mounted within a storage area of a vehicle, such as the trunk of an automobile. The pull will fit within a slot within the trunk's floor, so that the housing is concealed except for the top flange. When the pull is not in use, the plate will be rotated so that the hoop is inside the housing, thereby improving the appearance of the trunk. When the pull is needed, the plate is rotated until the end of the plate abuts the top edge of the housing's interior, so that the hoop projects upward. A cord can then be secured to the hoop for securing cargo in position within the trunk. Once the cord is secured to the hoop and a force is applied to the cord, the hoop will rotate so that it is parallel to the force applied by the cord. Once the pull is no longer needed, the cord may be detached, the hoop rotated so that it is aligned with the housing, and the plate rotated so that the hoop is again concealed.

It is therefore an object of the present invention to provide a concealable pull.

It is another object of the invention to provide a pull having a hoop that pivots between a concealed position and an exposed position for use.

It is a third object of the invention to provide a pull having a hoop that rotates to align itself parallel to a force applied to it through a cord.

These and other objects of the invention will become apparent through the following description and claims.

### BRIEF DESCRIPTION OF THE DRAWINGS

FIG. 1 is a top and front perspective view of a pull with a pivoting tie-down hoop according to the present invention, showing the hoop aligned parallel to the housing and exposed for use.

FIG. 2 is a top and front perspective view of a pull with a pivoting tie-down hoop according to the present invention, showing the hoop aligned parallel to the housing and exposed for use, and showing hidden features in phantom lines.

FIG. 3 is a top and front perspective view of a pull with a pivoting tie-down hoop according to the present invention, showing the hoop concealed.

FIG. 4 is a top and front perspective view of a pull with a pivoting tie-down hoop according to the present invention, showing the hoop concealed, and showing hidden features in phantom lines.

FIG. 5 is a top and front perspective view of a pull with a pivoting tie-down hoop according to the present invention, showing the hoop aligned perpendicular to the housing and exposed for use.

FIG. 6 is an exploded perspective view of a pull with a pivoting tie-down hoop according to the present invention.

Like reference numbers denote like elements throughout the drawings.

### DETAILED DESCRIPTION OF THE PREFERRED EMBODIMENTS

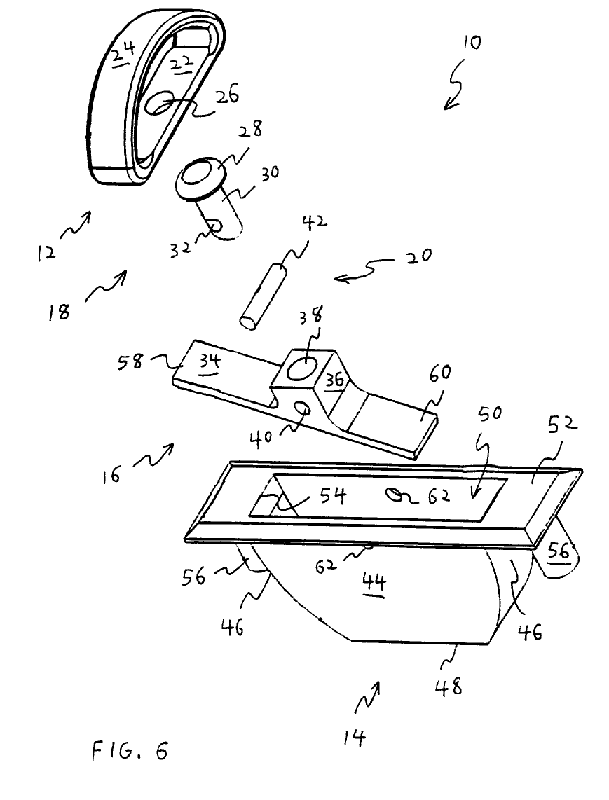

Referring to FIG. 6, the invention is a concealable pull 10 with a pivoting tie-down hoop 12. The pull 10 includes a housing 14, a plate 16, a stud 18, and a pin 20.

The hoop 12 includes a flat base 22 preferably defining a hole 24, and a curved gripping portion 26. The hole 24 is dimensioned and configured to receive a stud 18, having a head 28 and shaft 30. The stud may define a hole 32 through and perpendicular to its shaft 30, with the hole 32 being dimensioned and configured to receive a pin 42.

The plate 16 includes a base 34 and a stem 36. The stem 36 is angled so that when the stem 36 is vertical, the base 34 will be angled. The stem 36 defines a coaxial hole 38, being dimensioned and configured to receive the stud's shaft 30, and a perpendicular hole 40, dimensioned and configured to receive the pin 42. The base 34 includes a first end 58 and second end 60, with the end 58 extending farther than the end 60.

The housing 14 includes a pair of sides 44, a pair of ends 46, and a bottom 48, defining an interior 50 therewithin. A top flange 52 attaches to the sides 46 and ends 48 along the top edge 54. The top flange 52 may include means for securing the housing 14 within a slot defined in the bottom of a vehicle storage compartment, with a preferred means being a pair of hollow bosses 56. The sides 44 preferably define a hole 62, dimensioned and configured to receive the pin 42. The distance between the ends 46 of the housing 14 is slightly shorter than the distance between the ends 58,60 of the plate 16.

Within the assembled pull 10, the stud 18 passes through the hoop's hole 26, and then into the hole 38 of the plate's stem 36. The plate 16 is within the interior 50 of the housing 14. The pin 42 passes through the housing's holes 62, plate's hole 40, and stud's hole 32. The housing 14, plate 16, and stud 18 are thereby secured together by the pin 20, and the hoop 12 is secured to the plate by the head 28 of stud 18. This assembly provides a preferred and suggested means for pivotal securing of the plate 16 within the housing 14, and a preferred and suggested means for pivotal securing of the hoop 12 to the plate 16.

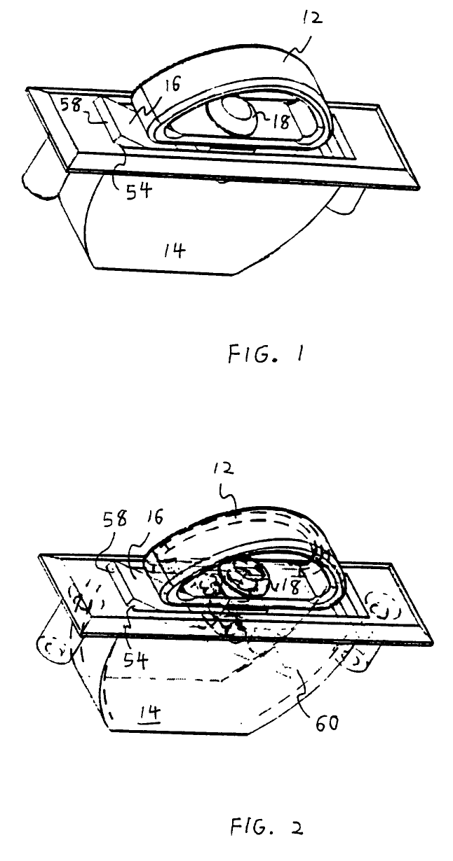

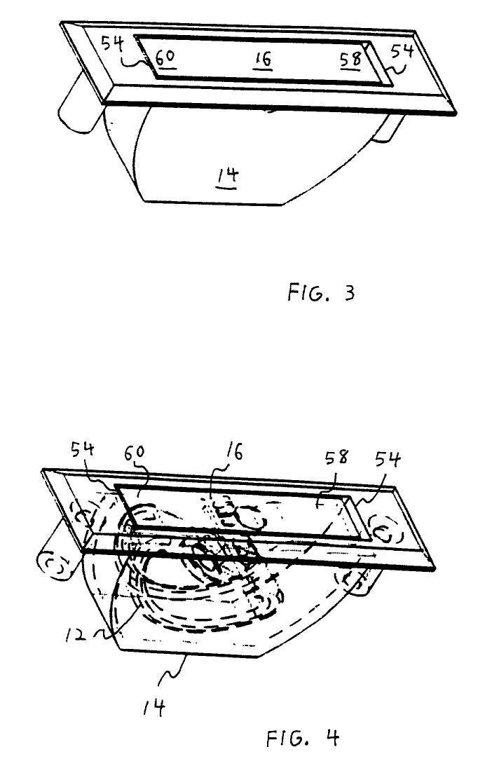

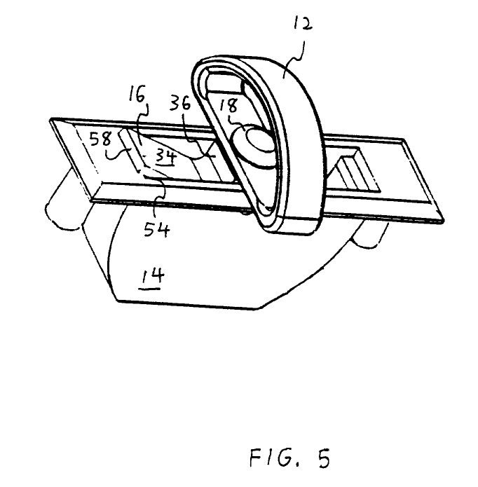

When not in use, the pull 10 will generally be stored with the hoop 12 concealed within the housing 14, illustrated in FIGS. 3-4. In this position, the ends 58,60 of the plate 16 are adjacent to the top edge 54 of the housing, with the end 58 abutting the edge 54 to limit the rotation of the plate 16. To use the pull 10, the plate 16 is pivoted so that the hoop 12 is exposed, which may be accomplished either by raising end 58 or pushing on end 60 of the plate 16. When the hoop 12 is positioned for use, the end 58 of the plate 16 abuts the edge 54 of the housing 14, again limiting rotation of the plate 16. The pull 10 is now in the configuration shown in FIGS. 1-2. A cord can be attached to the hoop 12. When a force is applied to the cord, the hoop 12 will rotate to align itself with the force applied, possibly as illustrated in FIG. 5. Once the cord is detached, the hoop 12 may be rotated so that it is aligned with the housing 14, as illustrated in FIGS. 1-2, and then the plate pivoted to the position illustrated in FIGS. 3-4 so that the hoop 12 is once again concealed.

It is to be understood that the invention is not limited to the preferred embodiments described herein, but encompasses all embodiments within the scope of the following claims.

We claim:

1. A pull, comprising:
a housing having a pair of sides, a pair of ends, a distance between said ends, a bottom, and a top edge, and means for securing said housing within a slot defined in the bottom of a vehicle's storage compartment;
a plate having a base and a stem, said base having a first end, a second end, and defining a distance between said ends;
means for pivotally securing said plate within said housing;
a hoop; and
means for pivotally securing said hoop to said plate.

2. The pull according to claim 1, wherein said housing includes a top flange.

3. The pull according to claim 2, wherein said means for securing said housing within a slot defined in the bottom of a vehicle's storage compartment is a pair of hollow bosses secured to said top flange.

4. The pull according to claim 1, wherein said first end of said plate's base extends farther than said second end of said plate's base.

5. The pull according to claim 1, wherein said stem is angled with respect to said base.

6. The pull according to claim 1, wherein said means for pivotally securing said hoop to said plate comprise:
a stud;
a hole within said hoop, said hoop's hole being dimensioned and configured to receive said stud; and
a coaxial hole within said stem, said stem's coaxial hole being dimensioned and configured to receive said stud.

7. The pull according to claim 6, wherein said means for pivotally securing said hoop to said plate comprise:
a pin;
a hole within each of said sides of said housing, said housing's holes being dimensioned and configured to receive said pin;
a hole within said plate's stem being perpendicular to said stem's coaxial hole, said perpendicular hole being dimensioned and configured to receive said pin; and
a hole within said stud, said stud's hole being dimensioned and configured to receive said pin.
